(19) United States
(12) Patent Application Publication
(10) Pub. No.: US 2001/0046858 A1
(43) Pub. Date: Nov. 29, 2001

(54) Method of generating network name in wireless network

(76) Inventor: Paulus Carpelan, Helsinki (FI)

Correspondence Address: PILLSBURY WINTHROP LLP, 1600 TYSONS BOULEVARD, MCLEAN, VA, 22102, US

(21) Appl. No.: 09/852,052

(22) Filed: May 10, 2001

(30) Foreign Application Priority Data
May 12, 2000 (FI) 20001139

(51) Int. Cl. H04Q 7/20

(52) U.S. Cl. 455/425; 455/524

(57) ABSTRACT

The present invention relates to a method of generating a network name for a base station (BS) in a wireless network, in which method a network name is selected and assigned to the base station (BS). The method comprises selecting an individual network name for the base station (BS), assigning said individual network name as the default network name of the base station (BS), and providing the base station (BS) with a marking from which said network name is read.

### BACKGROUND OF THE INVENTION

The present invention relates to wireless local area networks and particularly to the generation of a network name therein.

Wireless local area networks (WLAN) comprise terminals, such as portable computers provided with WLAN cards and communicating on a radio wave via a base station. A base station creates a wireless local area network around itself whose coverage is about 20 to 50 m. In Europe, wireless local area networks have 13 radio channels at their disposal, one of which the base station determines to be used for local area network communication. Each wireless local area network also has to have a special network name, which is a common identifier of the base station and the terminals coupled to the network.

A solution is previously known, wherein base stations of wireless local area networks are provided with certain default settings at the manufacturing stage, whereby for example the same network name is selected as the default value for all base stations.

The problem in the above solution is interference between adjacent wireless local area networks. For example, in an apartment house environment, several separate wireless local area networks may be located at short distances from each other. If in this case the same network name is set to be used by the base stations, a situation arises wherein terminals may accidentally end up in the wrong network, since the terminals select the network based on the network name. End users are not always capable of changing the network name and are not aware of the settings of surrounding interfering networks. This problem exists particularly in a home and small office environment. In larger companies, the situation is better since networks and network names are generally carefully planned. Furthermore, an expert IT organization often maintains the networks, whereby no problems arise in renaming networks.

### BRIEF DESCRIPTION OF THE INVENTION

The object of the invention is to solve the above problems by providing a user-friendlier solution enabling the use of network-specific network names without the need for a subsequent change of the network name that would require special knowledge. This object is achieved by a method of generating a network name for a base station in a wireless network, in which method a network name is selected and assigned to the base station. The method is characterized by selecting an individual network name for the base station, assigning said individual network name as the default network name of the base station and providing the base station with a marking from which said network name is read.

The invention also relates to a base station in a wireless network, the base station comprising means for communicating with a terminal on a radio channel, the terminal and the base station having a common network name. The base station is characterized in that an individual network name is selected and assigned to the base station, and the base station comprises a marking from which said network name is read.

The invention is based on the idea of assigning an individual network name to a base station before it is taken into use, preferably during manufacture, whereby adjacent separate wireless networks cannot have the same name. The network name is marked on the base station device in such a way that reading and inputting the network name in the right form in a terminal to be coupled to the network does not require special skills, and can easily be carried out by an end user.

In a first preferred embodiment of the inventive method, a network name is generated for a base station based on an individual serial number of the base station. A serial number is an individual character set assigned to the base station at the manufacturing stage and usable in full or partly as the network name in a manner agreed upon and described in the instructions for use. A network name can be generated from the serial number according to simple rules.

In a second preferred embodiment of the inventive method, the network name is printed on a sticker or the like, which is fastened to the base station. This ensures easy reading of the network name.

In a third preferred embodiment of the invention, the network name is read from a base station, and said network name is input in a terminal to be coupled to the network. Thereupon, the same individual network name is known both to the base station and to the terminal, and the terminal is then able to search for the radio channel on which communication takes place.

The preferred embodiments of the inventive method are disclosed in the attached dependent claims.

### BRIEF DESCRIPTION OF THE FIGURES

In the following, the invention will be described by way of example with reference to the attached figures, in which:

FIG. 1 is a flow chart of the method of the invention, and

FIG. 2 is a block diagram of the inventive system.

### DETAILED DESCRIPTION OF THE INVENTION

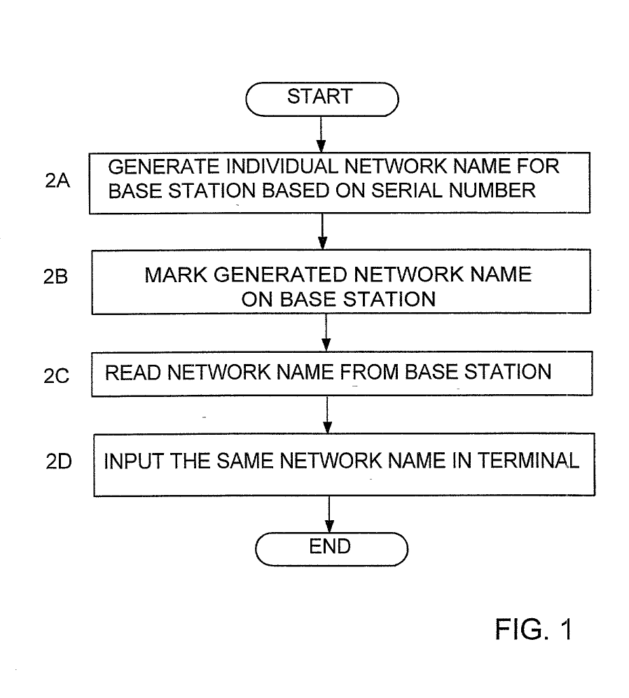

FIG. 1 is a flow chart of the method of the invention. In step 2A, an individual network name is generated for a base station and assigned as the default network name. In the present example, the network name is generated based on a running serial number of the base station, but other individual character series may also be used. The network name may be composed of the whole serial number or a given part of the serial number or it can be generated for example from a constant first part, to which the last four characters of the serial number are appended. In the present exemplary case, at the interval of ten thousand devices manufactured, a base station gets the same name, but in practice, the probability of these base stations being too close to each other is very slight. The network name generated in step 2B is marked on the base station device for example with a sticker. As distinct from the present example, the whole serial number may also be marked on the sticker, even if only part of the serial number is used as the network name. If the network name is generated from part of a long serial number or from a character series to be generated from the serial number in another way, clear instructions should be included in the instructions for use. In step 2C, the network name is read from the marking at the base station, and in step 2D, the network name of the base station is input in a terminal to be coupled to the network.

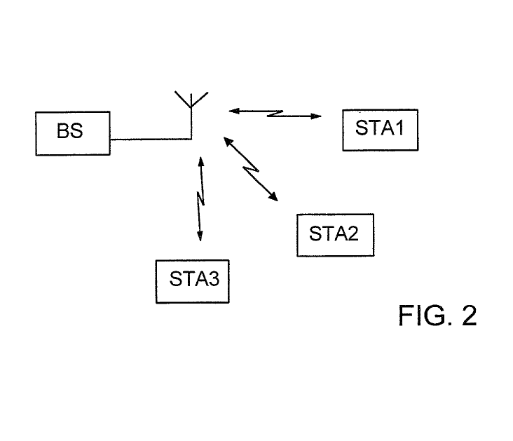

FIG. 2 is a block diagram of the inventive system. The wireless local area network shown comprises a base station BS and terminals STA1, STA2, STA3, which have a radio channel connection to the base station BS. The base station may be an ADSL terminal (Asymmetric Digital Subscriber Line), enabling a fast Internet connection. Such a wireless local area network is typically located at a home or a small office. The terminals STA1, STA2, STA3 may be for example portable computers having a local area network card or household appliances controlled from the network.

Let us assume that before delivery an individual network name and a certain radio channel to be used are set at the factory as default values for the base station BS. Before the terminals STA1, STA2, STA3 can be coupled to the network, the same network name has to be given to the terminals STA1, STA2, STA3. The network name of the base station BS, the name being e.g. part of a running serial number, can be read from a sticker attached to the base station BS and input in the terminals STA1, STA2, STA3. Once the base station BS is switched on, it starts to send a signal on the selected radio channel. At this point, the terminals STA1, STA2, STA3 are unaware of the radio channel selected, since at the factory, radio channels are assigned to base stations such that all radio channels are used equally in the entire production lot. Once the same network name is input in the terminals STA1, STA2, STA3 as is in the base station BS, the terminals STA1, STA2, STA3 can detect the signal including the network name sent by the base station BS and thus find the radio channel employed for communication.

The above method of selecting a radio channel and a network name aims at optimal network performance by minimizing intra-network interference. An individual network name and equal use of all radio channels minimizes the probability of interference between adjacent wireless local area network.

It is to be understood that the above specification and the related figures are only intended to illustrate the present invention. Different variations and modifications of the invention are apparent to those skilled in the art, without deviating from the scope and spirit of the invention disclosed in the attached claims.

1. A method of generating a network name for a base station in a wireless network, comprising:
selecting an individual network name for the base station,
assigning said individual network name as the default network name of the base station, and
providing the base station with a marking from which said network name can be read.

2. A method as claimed in claim 1, comprising:
generating the network name for the base station based on an individual serial number of the base station.

3. A method as claimed in claim 1 or 2, comprising:
printing the network name on the base station or on a sticker or the like to be fastened to the base station.

4. A method as claimed in any one of claims 1 to 2, comprising:
reading the network name from the base station, and
inputting said network name in a terminal to be coupled to the network.

5. A base station in a wireless network, the base station comprising:
means for communicating with a terminal on a radio channel, the terminal and the base station having a common network name, which is selected and assigned to the base station, and
a marking from which said network name can be read.
